(19) United States
(12) Patent Application Publication
(10) Pub. No.: US 2006/0044121 A1
(43) Pub. Date: Mar. 2, 2006

(54) Device and method to facilitate coupling of a hitch

(76) Inventor: Jack R. Jarnagin, Jefferson, TN (US)

Correspondence Address: JACK R. JARNAGIN, 1233 CORA RD., JEFFERSON, TN, 37760, US

(21) Appl. No.: 10/925,045

(22) Filed: Aug. 25, 2004

(51) Int. Cl. G08B 21/00

(52) U.S. Cl. 340/431; 340/686.2

(57) ABSTRACT

A device and method to facilitate the coupling of trailer with a socket to a truck with a ball, in which a direction signal is generated by a transmitter on the trailer indicative of the direction the socket is from the ball, and a distance signal returned to a receiver on the truck is timed to determine the distance between the ball and the socket, which signals are used to generate an indication on a display.

This invention relates to a device and a method for simplifying the alignment of hitch components in order to effect a physical, articulated connection between a prime mover or towing vehicle, and a towed vehicle, such as between a pickup truck and a trailer, for example.

### BACKGROUND OF THE INVENTION

The universal means for connecting a prime mover, such as a pickup truck, for example, to a towed vehicle, such as a trailer, for example, is commonly called a hitch. A hitch, which is common in the prior art, basically consists of three components, a ball, a socket shaped, when closed, to mate with the ball by encircling the ball below its equator to thereby preclude disengagement while permitting articulation therebetween, and a latch means for releasably securing the socket in its closed position in engagement with the ball. The ball is affixed directly or indirectly to the frame of the prime mover and positioned centrally of the rear of the prime mover and projects upward therefrom in a manner to permit unobstructed access by the socket. The socket is attached to a central tongue formed on the towed vehicle, and when secured in engagement with the ball by closing the latch means, functions to effect a positive and yet articulated connection between the prime mover and the towed vehicle, The tongue of the trailer is typically supposed by a jack or other support means to be an elevation higher than the ball and ideally the socket can be lowered onto the ball and secured thereto by the latch means.

The ball must be positioned below the socket so that lowering the tongue of the towed vehicle will bring the socket into engagement with the ball connection and the latch means closed. Fine adjustments of the trailer tongue to achieve the desired alignment are often difficult, particularly when the driver alone must exert the physical effort required to reposition the towed vehicle, especially when the rolling resistance of the towed vehicle is high, such as when it is loaded and/or positioned on a soft surface. Thus, properly aligning a prime mover with a towed vehicle in order to make the connection of the ball with the socket is highly desirable, and has long been a problem. The ball and socket are not normally visible to the driver of the prime mover, and without an assistant to direct the maneuvering of the prime mover as it is backed toward the towed vehicle, it is likely that multiple attempts will be necessary to achieve the proper positioning of the ball under the socket.

The prior art in attempting to resolve this problem has provided the driver with certain aids. One such aid is the provision of a mirror or mirrors that permit a driver to see the ball and socket from the driver's seat in the prime mover. However, mirrors do not adequately solve the problem because the images are reversed, which makes maneuvering the prime mover to achieve to desired alignment difficult, especially for those inexperienced with such a reverse images. Another aid of the prior art is a funnel shaped member fastened to the prime mover and designed to engage the tongue and physically move the socket until it is over the ball. This aid raises other problems since the power of the prime mover can cause a towed vehicle, which often has no parking brake, to “jump” any restraining blocks, and thereby become an uncontrolled ran-away, possible endangering personnel in the area or damaging property, including perhaps the trailer itself and/or its contents.

### SUMMARY OF THE INVENTION

The present invention simplifies the connection of a prime mover with a towed vehicle by providing a visible representation of the actual relationship between the hitch components. That visible representation is available to the driver of the prime mover in the position he or she occupies for the normal operation of the prime mover, and allows the driver to maneuver the prime mover to quickly and accurately position the ball under the socket. No mirrors are employed so the visible representation is not a reverse image of the true relationship between the ball and the socket, which shortens the learning curve for novice operators, and permits rapid connections by those more experienced in its use. Additionally, because physically contact between the prime mover and the towed vehicle is not required, the desired alignment may be achieved safely, and without endangering personnel or damaging property.

### DESCRIPTION OF THE DRAWINGS

FIG. 1 is a pictorial representation of a pickup truck, portions of which have been cut away for clarity, and a trailer incorporating the present invention;

FIG. 2 is a detailed view, in elevation, of the socket portion of the hitch shown in FIG. 1;

FIG. 3 is a detailed view, in elevation, of the ball portion of the hitch shown in FIG. 1; and

FIG. 4 is a plan view of the display, according to the present invention, mounted in the pickup truck.

### DETAILED DESCRIPTION OF A PREFERRED EMBODIMENT

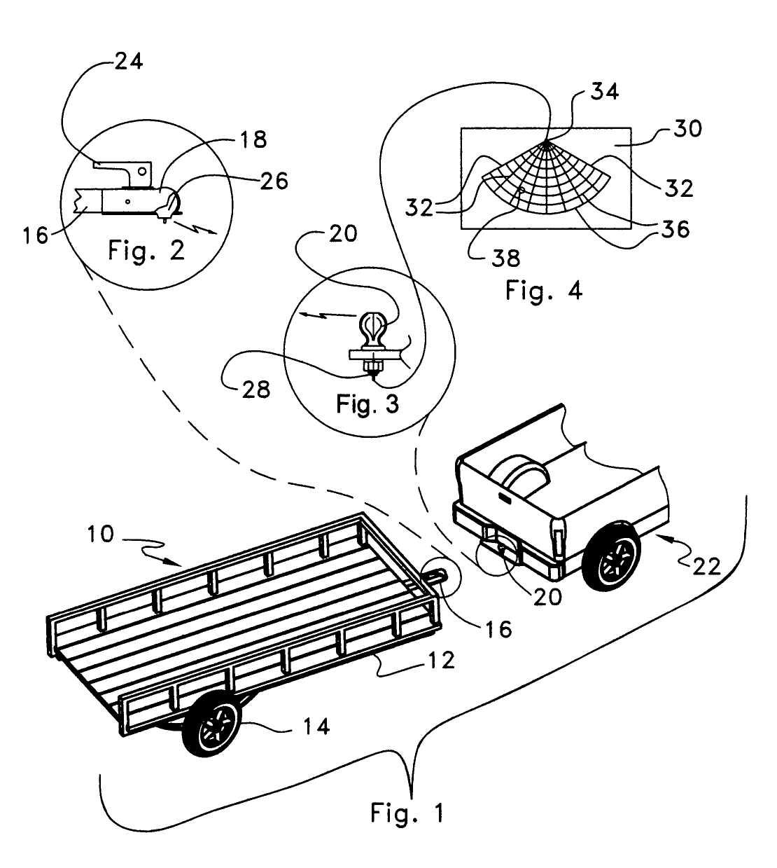

Referring now to FIG. 1, there is shown a trailer, indicated generally at 10, having a frame 12 mounted on wheels, one of which is shown at 14. The frame includes a central tongue 16 having a socket 18 at its outer end, as best seen in FIG. 2. The socket 18 is movable between a closed position in which it engages the ball 20, encircling the ball below its equator, which ball is secured to the rear of the truck 22, and an open position in which the socket 18 may be disengaged from the ball 20. A conventional latch 24 is provided on the socket to releaseably secure the socket 18 in its closed position.

A signal sending unit 26, which preferably is battery operated, is incorporated into or otherwise mounted on or in close proximity to the socket 20 and sends signals to a receiver unit 28 incorporated into or positioned in close proximity to the ball 20. The receiver unit 28 is capable of determining the direction from which the unit 26 signal is sent. The distance the socket 18 is from the ball 20 in that direction is determined by calculating the time required for the return of a distance signal sent by the receiver unit 28 to the sending unit 26. These two signals generated by the unit 26, i.e., the directional signal and the returned distance signal, may be multiplexed, or may be simultaneously generated at different frequencies, in either case using techniques well known in the electronic arts. Whether multiplexed or not, the unit 28 must be designed to be compatible with the unit 26.

The receiver unit 28 is connected to an inboard monitoring indicator or display 30. The display 30 is provided with a plurality of radii 32, the intersection of which defines a point 34 representative of the ball 20. A plurality of circular arcs 36, each of which is centered on the point 34, are provided on the display 30. A processor, not shown, processes the directional signal and the distance signal to generate a spot of light 38 on the display 30, which spot of light will be representative of the position of the socket 18 in the X-Y or horizontal plane. The driver in backing the truck 22 toward the trailer 10 has only to observe the position of the spot of light relative to the intersection 34, and maneuver the truck so that the spot 38 is positioned at the point 34. Once that positioning of the spot 38 is achieved, the socket will be over the ball 20, and the connection of the hitch thereafter may be readily made.

It is also anticipated that the audible signal, or other type of signals, such as a flashing light, for example, may be provided to assist the driver by indicating when the position of the spot 38 is within an acceptable tolerance of the point 34.

While a preferred embodiment of the present invention has been illustrated and described herein, it is to be understood that various changes may be made without departing from the spirit of the invention, as defined by the scope of the appended claims.

What is claimed is:

1. A method of achieving proper alignment of hitch components, including a ball and a socket, to effect an articulated connection between a prime mover and a towed vehicle, wherein said ball is affixed to said prime mover and said socket is affixed to said towed vehicle, comprising the steps of:
providing said towed vehicle with a transmitter to create a signal representative of the location in the X-Y plane of said socket;
providing a receiver on said prime mover for receiving said signal;
displaying said signal on a screen visible to the operator of the prime mover;
providing said screen with an arc pattern of substantially 90 degrees with radii intersecting at a point representative of the location in the X-Y plane of said ball; and
propelling said prime mover generally toward said towed vehicle while maneuvering said prime mover in a manner to superimpose said signal on said point.

2. A device to facilitate the positioning of a prime mover relative to a trailer to effect a connection of a hitch, said hitch having a ball component affixed to said prime mover and a socket component affixed to said trailer; said device comprising:
a transmitter carried by said trailer and capable of transmitting a signal representative of the location in the X-Y plane of said socket;
a receiver on said prime mover for receiving said signal;
a screen for displaying said signal;
said screen having a grid pattern including a plurality of radii intersecting at a point, which point is representative of the position in the X-Y plane of said ball component.

3. In a hitch for effecting an articulated connection between a prime mover and a towed vehicle, said hitch including a ball component carried by said prime mover and a socket component carried by said towed vehicle, the improvement comprising:
a transmitter carried by said trailer and capable of transmitting a signal representative of the location in the X-Y plane of said socket;
a receiver on said prime mover for receiving said signal;
a screen for displaying said signal; and
said screen having a grid pattern including a plurality of radii intersecting at a point, which point is representative of the position in the X-Y plane of said ball component.
